(19) United States
(12) Patent Application Publication
(10) Pub. No.: US 2007/0011236 A1
(43) Pub. Date: Jan. 11, 2007

(54) RELATIONSHIP DEFINITION AND PROCESSING SYSTEM AND METHOD

(75) Inventor: Vasantha K. Ravula, Sammamish, WA (US)

Correspondence Address: HALLISKY & PHILIPP, 1725 WESTLAKE AVENUE NORTH, SUITE 150, SEATTLE, WA, 98109, US

(73) Assignee: RELGO NETWORKS, INC., Sammamish, WA (US)

(21) Appl. No.: 11/426,883

(22) Filed: Jun. 27, 2006

Related U.S. Application Data
(63) Continuation-in-part of application No. 11/224,052, filed on Sep. 13, 2005.
(60) Provisional application No. 60/522,291, filed on Sep. 13, 2004.
(60) Provisional application No. 60/595,365, filed on Jun. 27, 2005.

(51) Int. Cl. G06F 15/16

(52) U.S. Cl. 709/204

(57) ABSTRACT

A computer implemented method of defining relationships is provided herein.

### RELATED APPLICATIONS

This application is a continuation-in-part of U.S. patent application Ser. No. 11/224,052, entitled RELATIONSHIP DEFINITION AND PROCESSING SYSTEM AND METHOD, filed on Sep. 13, 2005, which claims the benefit of U.S. Provisional Patent Application No. 60/522,291, entitled A RELATIONSHIP MANAGEMENT SYSTEM REPRESENTING RELATIONS BETWEEN ENTITIES WITH A RELATION TYPE, AIDING AND CAPTURING RELATION CHARACTERISTICS USING COLLABORATION TOOLS, PUBLISHING QUERYING AND ANALYZING HISTORICAL DATA, REQUESTING REFERRAL INFORMATION FROM PEER AND SERVICES, filed on Sep. 13, 2004, and U.S. Provisional Patent Application No. 60/595,365, entitled THIS INVENTION IS A SOFTWARE PROCESS TO CREATE RELATIONS NETWORK BY DEFINING A TIE (RELATION TYPE) AND ASSOCIATING IT BETWEEN ENTITIES, INFERRING RELATIONS FROM NETWORK BASED ON TYPE DEFINITION, EXCHANGING RELATION AS METADATA DURING COLLABORATION ACTIVITY, MEASURING RELATION STRENGTH, TRUST FACTOR, PRIVACY CONTROLLING THE INFORMATION BEING SHARED, PUBLISHING AND SERVING ALERTS TO RELATION NETWORK ENTITIES, PERSISTING AND USING ENTITY TESTIMONIALS TO CALCULATE THE TRUST FACTOR., filed on Jun. 27, 2005, which are hereby incorporated by reference.

### FIELD

The present invention generally relates to relations and, more particularly, to relations in communications systems.

### BACKGROUND

Communication networks are well known in the computer communications field. By definition, a network is a group of computers and associated devices that are connected by communications facilities or links. Network communications can be of a permanent nature, such as via cables, or can be of a temporary nature, such as connections made through telephone or wireless links. Networks may vary in size, from a local area network (“LAN”), consisting of a few computers or workstations and related devices, to a wide area network (“WAN”), which interconnects computers and LANs that are geographically dispersed, to a remote access service, which interconnects remote computers via temporary communication links. An internetwork, in turn, is the joining of multiple computer networks, both similar and dissimilar, by means of gateways or routers that facilitate data transfer and conversion from various networks. A well-known abbreviation for the term internetwork is “internet.” As currently understood, the capitalized term “Internet” refers to the collection of networks and routers that use the Internet Protocol (“IP”), along with higher-level protocols, such as the Transmission Control Protocol (“TCP”) or the Uniform Datagram Packet (“UDP”) protocol, to communicate with one another.

Many communication systems that utilize communication networks have listings of contacts that may be reached using the communications system. Likewise, Personal Information Managers (“PIMs”) may have listings of contacts that may allow a user to communicate with the contact via a communications network.

Such systems have proved commercially successful and desirable for a number of reasons. In particular, PIMs allow users to arrange their contacts in lists and to synchronize the contacts with multiple devices. However, the categorization of contacts using conventional PIMs and communication systems is generally arbitrary and does not capture relationships between contacts.

One drawback of current social networks or other organizational networks is that entities are merely linked, and link is called a relationship. This mechanism allows entity connection, traversing through the connections and sometimes determining a connection path. However, current networks fail to define the links to other entities in a structured manner.

Previous systems have been proposed to extract relations by scavenging PIMs', information, organizing the entities in address books and connecting address book entities. Likewise, there are directory systems and address book systems for grouping with associated categories. These mechanisms use unbounded and unstructured categories and fail to provide a structured environment for defined relations.

Additionally, current relationship systems fall short of the privacy needed by entities in the social networks. Social networks benefit from a mechanism to control who can reveal what information about the other person or group.

Additionally, current systems that enable user-defined contact networks, lack the ability to share or merge user's networks. Existing “Friend of a Friend” (“FOAF”) networks have mechanism to group contacts, but fall short of having private and shared networks. Similarly, such FOAF networks man import or export contacts, but not the networks themselves.

FOAF networks typically utilize user characteristics to match up services and some times match up trust level by endorsements and connections. However, current FOAF networks are unable to effectively take into account type of relationship before taking into account endorsements, trusted referrals, and relationship and transactions based relationship strength measurement.

### BRIEF DESCRIPTION OF THE DRAWINGS

FIG. 1 is a pictorial diagram of a number of interconnected devices that provide a connected user device relationship defining functionality in accordance with various embodiments.

FIG. 2 is a block diagram of a user device that provides an exemplary operating environment for one embodiment.

FIG. 3 is a block diagram of a relationship server that provides an exemplary operating environment for one embodiment.

FIG. 4 is a diagram illustrating the actions taken by devices in a relationship system for processing a relationship defining transaction in accordance with one embodiment.

FIG. 5 is a flow diagram illustrating a relationship defining routine in accordance with one embodiment.

FIG. 6 is a flow diagram illustrating a relationship processing routine in accordance with one embodiment.

FIG. 7 is a diagram illustrating the actions taken by devices in a relationship system for processing a relationship definition in accordance with one embodiment.

FIG. 8 is a flow diagram illustrating a relationship and link processing routine in accordance with one embodiment.

FIGS. 9-11 illustrate exemplary user interfaces suitable for use in various embodiments.

FIG. 12 is a flow diagram illustrating a shared network request routine in accordance with one embodiment.

FIG. 13 is a flow diagram illustrating a trusted network request routine in accordance with one embodiment.

FIG. 14 is a flow diagram illustrating a shares resource processing routine in accordance with one embodiment.

FIG. 15-17 illustrate exemplary user interfaces suitable for use in various embodiments.

FIG. 18 is a flow diagram illustrating a shared resource request parsing subroutine in accordance with one embodiment.

### DETAILED DESCRIPTION

The detailed description that follows is represented largely in terms of processes and symbolic representations of operations by conventional computer components, including a processor, memory storage devices for the processor, connected display devices and input devices. Furthermore, these processes and operations may utilize conventional computer components in a heterogeneous distributed computing environment, including remote file Servers, computer Servers and memory storage devices. Each of these conventional distributed computing components is accessible by the processor via a communication network.

Reference is now made in detail to the description of the embodiments as illustrated in the drawings. While embodiments are described in connection with the drawings and related descriptions, there is no intent to limit the scope to the embodiments disclosed herein. On the contrary, the intent is to cover all alternatives, modifications and equivalents. In alternate embodiments, additional devices, or combinations of illustrated devices, may be added to, or combined, without limiting the scope to the embodiments disclosed herein.

Social networking is one way to organize people in a network depending on their social, familial and/or business affiliations. Often this may be accomplished by analyzing the communication patterns of people. However, people also organize themselves in defined relationships. By capturing the natural organization of defined relationships in to computerized model, it is possible to utilize these defined relations to give users a user-friendly way of organizing their contacts and information.

In various exemplary embodiments, defined relationships can be grouped into groups of relation types that enable a user to define relations in one or more ways to form a contact network. A contact network is network of family members, workplace members or any group of contacts defined in a group of relation types. By changing the type of group of relation types, it is possible to generate a different type of relationship network. Additionally, in some embodiments, a contact may have more than one specified relationship. For example a contact could have the “Family” relationship “Father” and the “Work” relationship “Reports to.”

Relationship (or relation) type indicates the type of relation that is set between two entities. When setting a relation, the user may select one or more types from predefined types categorized according to groups (e.g., family, work, social, computers, etc.). Some predefined types may be provided with an exemplary application; while other types may be predefined by a user. A type is may have various characteristics, such as the group it is in, its privacy settings, etc.

Groups provide a way to organize relations. Groups make it simpler for a user to find the relations they are looking for based on a search within a specified group. Some system-defined groups may be provided to a user with exemplary implementations. However, a user may also create his/her custom defined group(s). Likewise, a user can create a defined group that specifies one or more groups as having the types of relations that the user wishes to contain in the combined defined group. For example, a user wishing to have family and workplace relations both stored in their “MyWorkingFamily” group, might specify a “family” group type and a “workplace” group type as defining the kind of group that MyWorkingFamily should be.

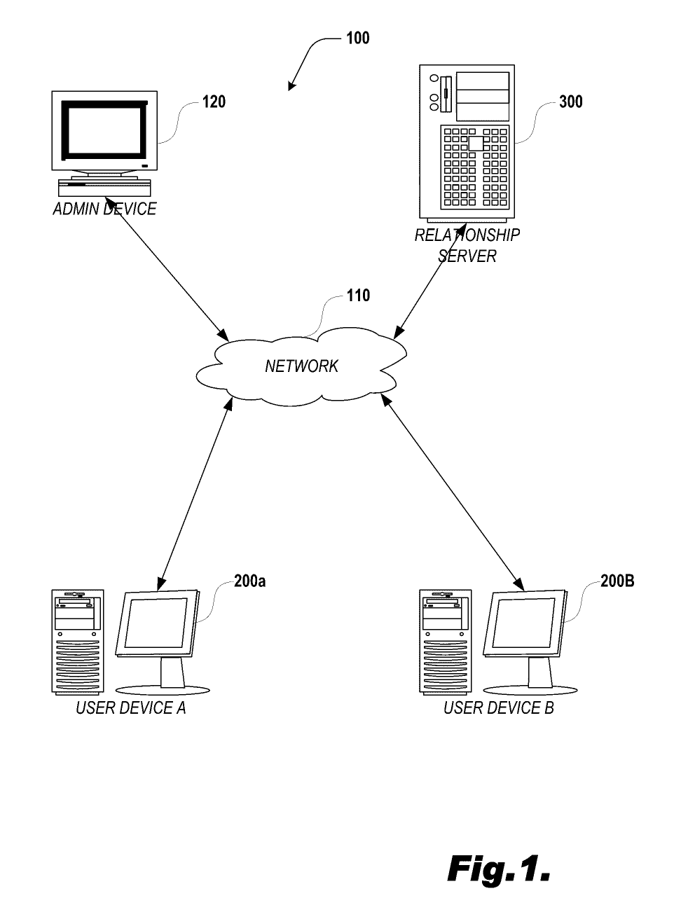

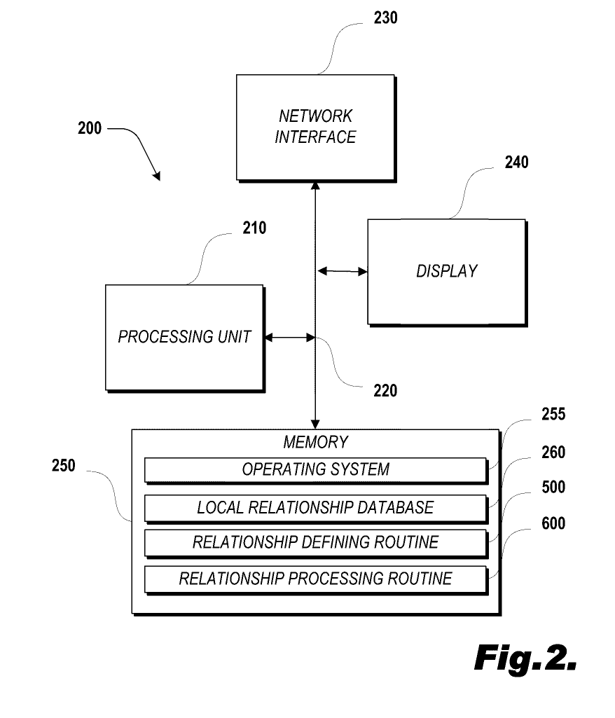

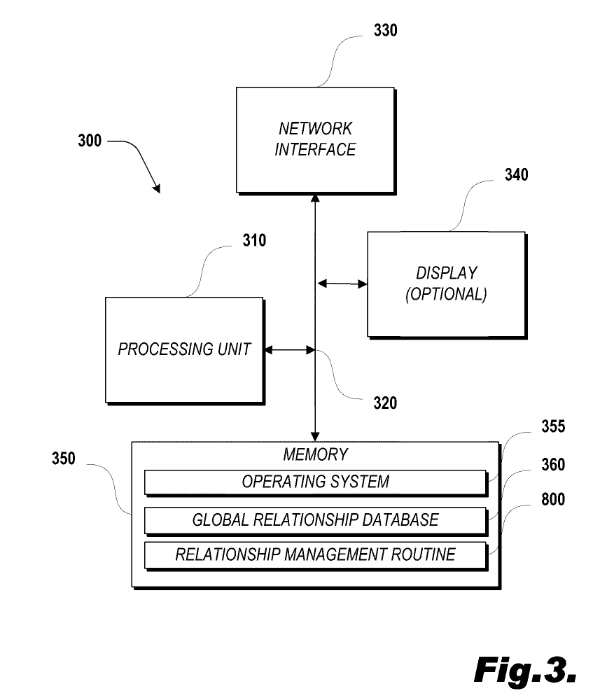

To show the operations of such relationship networks, FIG. 1 illustrates an exemplary integrated relationship system 100 having a number of devices used in exemplary embodiments. FIG. 1 illustrates a first user device 200A (illustrated in FIG. 2 and described below), a network 110, such as a wire or wireless communications network. Also in communication with the network 110 is a second user device 200B, a relationship server 300 (illustrated in FIG. 3 and described below) and optional administration device 120. In alternate embodiments, there may be more user devices 200, relationship servers 300 or administration devices 120. In further embodiments, the roles of one or more of a user device 200, a relationship server 300 and/or an administration device 120 may be performed by an integrated device (not show) or may be distributed across multiple other devices (not shown). In still further embodiments, still additional devices (not shown) may be utilized in the relationship system 100.

FIG. 2 illustrates several components of an exemplary user device 200. In some embodiments, the user device 200 may include many more components than those shown in FIG. 2. However, it is not necessary that all of these generally conventional components be shown in order to disclose an illustrative embodiment. As shown in FIG. 2, the user device 200 includes a network interface 230 for connecting to the network 110. Those of ordinary skill in the art will appreciate that the network interface 230 includes the necessary circuitry for such a connection and is constructed for use with the appropriate protocol.

The user device 200 also includes a processing unit 210, a memory 250 and may include an optional display 240, all interconnected along with the network interface 230 via a bus 220. The memory 250 generally comprises a random access memory (“RAM”), a read only memory (“ROM”), and a permanent mass storage device, such as a disk drive. The memory 250 stores program code for a relationship defining routine 500 and a relationship processing routine 600, in addition to a local relationship database 260. In addition, the memory 250 also stores an operating system 255. It will be appreciated that these software components may be loaded from a computer readable medium into memory 250 of the user device 200 using a drive mechanism (not shown) associated with a computer readable medium, such as a floppy disc, tape, DVD/CD-ROM drive, memory card, via the network interface 230 or the like.

Although an exemplary user device 200 has been described that generally conforms to conventional general purpose computing devices, those of ordinary skill in the art will appreciate that a user device 200 may be any of a great number of devices capable of communicating with the network 110 or with the relationship server 300.

FIG. 3 illustrates several components of the relationship server 300. In some embodiments, the relationship server 300 may include many more components than those shown in FIG. 3. However, it is not necessary that all of these generally conventional components be shown in order to disclose an illustrative embodiment. As shown in FIG. 3, the relationship server 300 includes a network interface 330 for connecting to the network 110. Those of ordinary skill in the art will appreciate that the network interface 330 includes the necessary circuitry for such a connection and is constructed for use with the appropriate protocol.

The relationship server 300 also includes a processing unit 310, a memory 350 and may include an optional display 340, all interconnected along with the network interface 330 via a bus 330. The memory 350 generally comprises a RAM, a ROM, and a permanent mass storage device, such as a disk drive. The memory 350 stores program code for a relationship and link processing routine 800, in addition to a global relationship database 360. In addition, the memory 350 also stores an operating system 355. It will be appreciated that these software components may be loaded from a computer readable medium into memory 350 of the relationship server 300 using a drive mechanism (not shown) associated with a computer readable medium, such as a floppy disc, tape, DVD/CD-ROM drive, memory card, via the network interface 330 or the like.

Although an exemplary relationship server 300 has been described that generally conforms to conventional general purpose computing devices, those of ordinary skill in the art will appreciate that a relationship server 300 may be any of a great number of devices capable of communicating with the network 110 or with a user device 200.

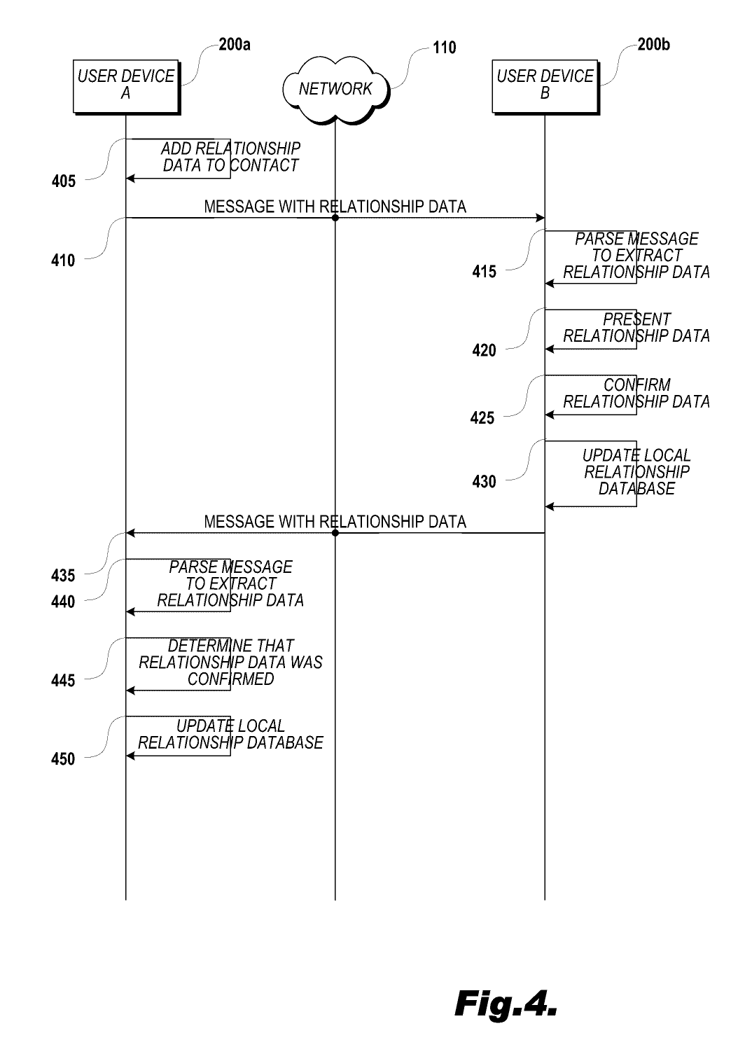

FIGS. 4-8 illustrate exemplary steps to process relationships in an exemplary relationship system 100. Some transactions in the relationship system 100 may be more or differently networked than others. Accordingly, in some embodiments, the number and types of devices may vary.

FIG. 4, for example, illustrates an exemplary peer-to-peer relationship defining transaction where the steps of the transaction take place between at least two peer-level user devices 200A-B. The transaction begins with the first user device 200A adding 405 a relationship data (e.g., by specifying a predefine relationship selected from a group of relationship types) to a contact. The first user device 200A sends 410 a message with the relationship data to the contact at the second user device 200B via a network 110. At second user device 200B, the message is parsed 410 to extract the relationship data. Next, the relationship data is presented 420 on the second user device 200B. A user viewing the data may confirm 425 that the relationship data is correct and second user device 200B updates 430 a local relationship database (e.g., local relationship database 260) with a confirmation of the relationship. After which, the user of second user device 200B may send 435 a reply message, with relationship data, back to first user device 200A via the network 110.

First user device 200A determines 445 that the relationship data was confirmed (e.g., via header information contacts information attached data, and alike) and updates 450 a local relationship database (e.g., relationship database 260 of first user device 200A) with the confirmation of the relationship.

The offer and acceptance of the relationship allows each user of the system to define their own relationships, while still allowing their relations to likewise define and control their relationships, thereby preserving a desirable level of personal control over personal information. In other words, a person can propose a marriage, but only when the proposal is accepted can there be a true “fiance” relationship.

While an exemplary transaction and types of device has been identified, it will be apparent that in alternate embodiments other types of device may process still other forms transactions. For example, authentication of a user from information provided at the first or second user device 200A, 200B.

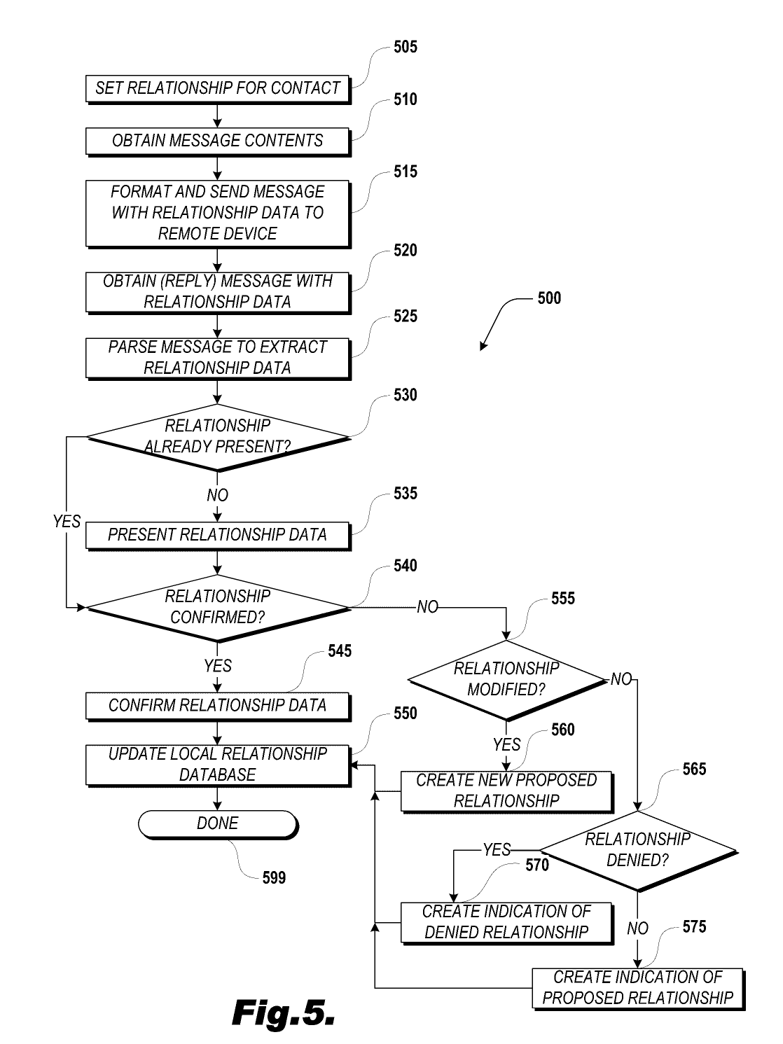

FIG. 5 illustrates an exemplary relationship defining routine 500 suitable for execution on a user device 200. Relationship defining routine 500 begins at block 505 where a relationship is set for a contact. In block 510, the contents of a message are obtained (e.g., a user composes a message, selects a predetermined message or otherwise obtains message contents). In block 515, a message is formatted with the message contents and is sent with the relationship data to a remote device (such as another user device 200 or a relationship server 300). Relationship data may accompany the message in any of a variety of manners, including but not limited to, attachments, header information, structured message contents, integrated data and the like.

In some embodiments, the defining of relationship is an asynchronous process. Therefore, in some embodiments, there may be a delay until a reply message is obtained in block 520. Once received, the reply message is parsed to extract its relationship data in block 525. It will be appreciated that a message obtained from a remote device may be responsive to an originally sent message or may designate its own relationship data.

Accordingly, in decision block 530, a determination is made whether the relationship is already present on a current device. If the relationship is not currently present, processing proceeds to block 535 where the relationship data is presented for a user to determine its status. After which, processing proceeds to decision block 540.

If, however, in decision block 530 it was determined that relationship data was already present, processing proceeds directly to decision block 540 where determination is made whether the relationship data has been confirmed (e.g., after presentation to user or in the reply message obtained in block 520). If in decision block 540 it is determined that the relationship is confirmed, processing proceeds to block 545 where the local record of the relationship is confirmed and the local relationship database (e.g., database 260) is updated in block 550. Relationship defining routine 500 ends at block 599.

However, if in decision block 540 it was determined that the relationship was not confirmed, processing proceeds the decision block 555 where determination is made whether the relationship was modified. One example of a modified relationship might be where a person was designated a fiancé in a family relationship but was modified to be a spouse (i.e., got married). Other modified relationship may be apparent depending on the relationship types in question.

If in decision block 555 it was determined that the relationship was modified, in block 560 a new proposed relationship is created and processing proceeds to block 550 as described above. The new proposed relationship could be sent in another message (such as is block 515).

In some embodiment, a user may add notes and/or other metadata to the relationship link before or after a relationship is confirmed. For example a service provider make a note on the link to their client regarding the quality of the relationship, e.g., “paid bills promptly” or the like.

However, if in decision block 555 it was determined the relationship was not modified; processing proceeds to block 565 where determination is made whether the relationship was denied. A simple example of a denied relationship might be when one spouse divorces another spouse, the spousal relationship would therefore be broken and accordingly, the relationship could be denied (another way of implementing this may categorize this as a “modified” relationship). If the relationship was denied, as determined in decision block 565, processing proceeds to block 570. In block 570, an indication of the denied relationship is created and processing proceeds to block 550.

If, however, in decision block 565, it was determined that the relationship was not denied, processing proceeds to block 575 where an indication of a proposed relationship is created and processing proceeds to block 550.

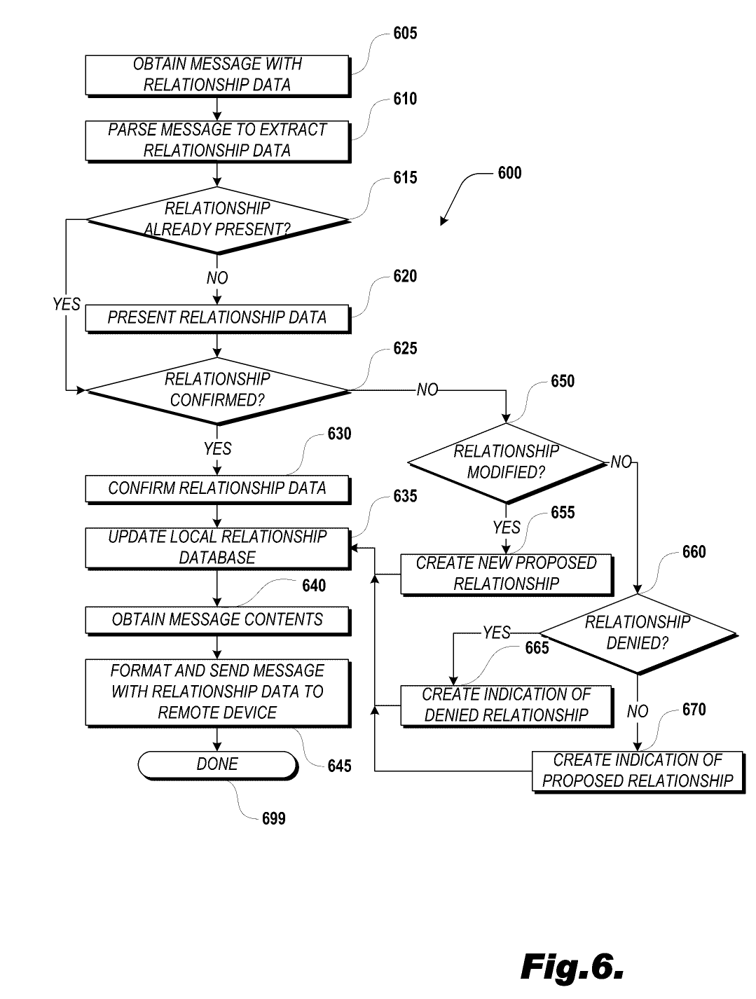

While FIG. 5 illustrates the logic of a routine proposing to define a relationship, FIG. 6 illustrates an exemplary relationship processing routine 600 for processing the proposed relationship. Relationship processing 600 begins at block 605 with a current device obtaining a message having relationship data. In block 610, the message is parsed to extract the relationship data. In decision block 615, a determination is made whether the relationship is already present at the current device (e.g., by looking in a local relationship database such as relationship database 260). If in decision block 615 it was determined that the relationship is not present, processing proceeds to block 620 where the relationship data is presented to a user.

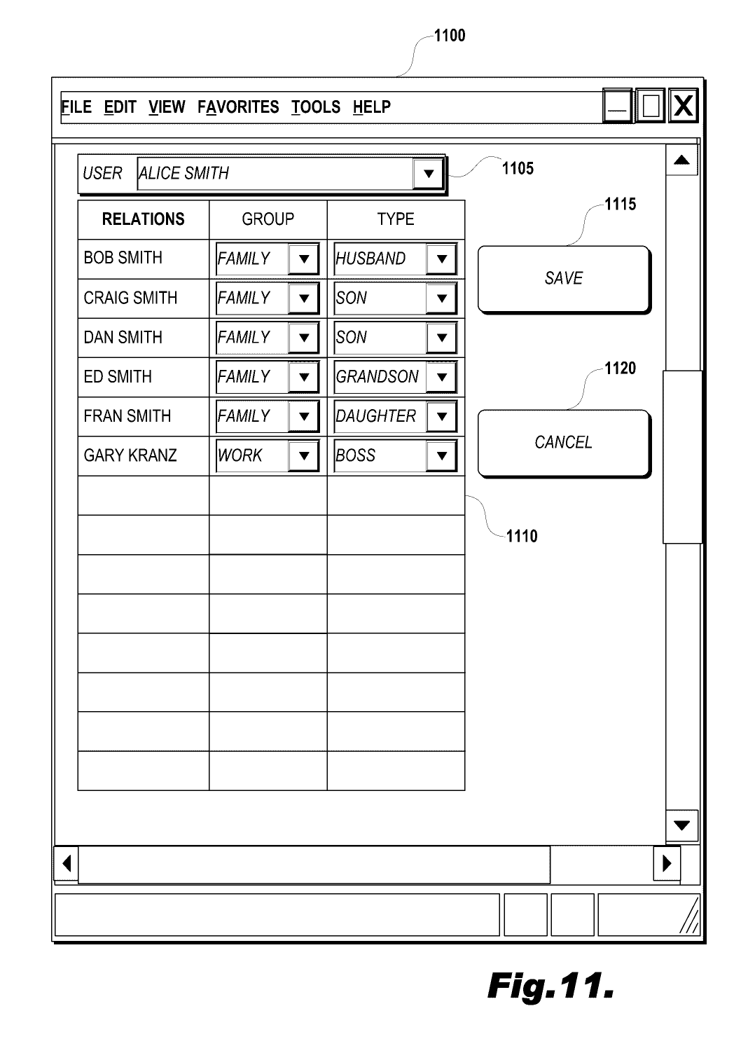

In one exemplary embodiment, the relationship is presented for confirmation based on matching the relationship type to a compatible group of relations already defined by the user. For example, if the user has a group of family relationship contacts, the proposed relationship may be presented as if it were part of a relationship defining user interface (see FIG. 11 for example).

Next, in decision block 625. Likewise, if the relationship was determined to be present in decision block 615, processing proceeds to decision block 625 where determination is made whether the relationship was confirmed. If in decision block 625 it is determined that the relationship is confirmed, processing proceeds to block 630 where the local record of the relationship is confirmed and the relationship database (e.g., local relationship database 260 or global relationship database 360) is updated in block 635. Next, in block 640, message contents are obtained. In block 645, a message is formatted with the message contents along with the relationship date and sent to remote device (e.g., an originating user device 200 belonging to a contact whose relationship data was updated). Relationship processing routine 600 ends at block 699.

However, if in decision block 625 it was determined that the relationship was not confirmed, processing proceeds the decision block 650 where determination is made whether the relationship was modified. If in decision block 650 it was determined that the relationship was modified, in block 655 a new proposed relationship is created and processing proceeds to block 635 as described above.

However, if in decision block 650 it was determined the relationship was not modified; processing proceeds to block 660 where determination is made whether the relationship was denied. If the relationship was denied, as determined in decision block 660, processing proceeds to block 665. In block 665, an indication of the denied relationship is created and processing proceeds to block 635.

If, however, in decision block 660, it was determined that the relationship was not denied, processing proceeds to block 670 where an indication of a proposed relationship is created and processing proceeds to block 635.

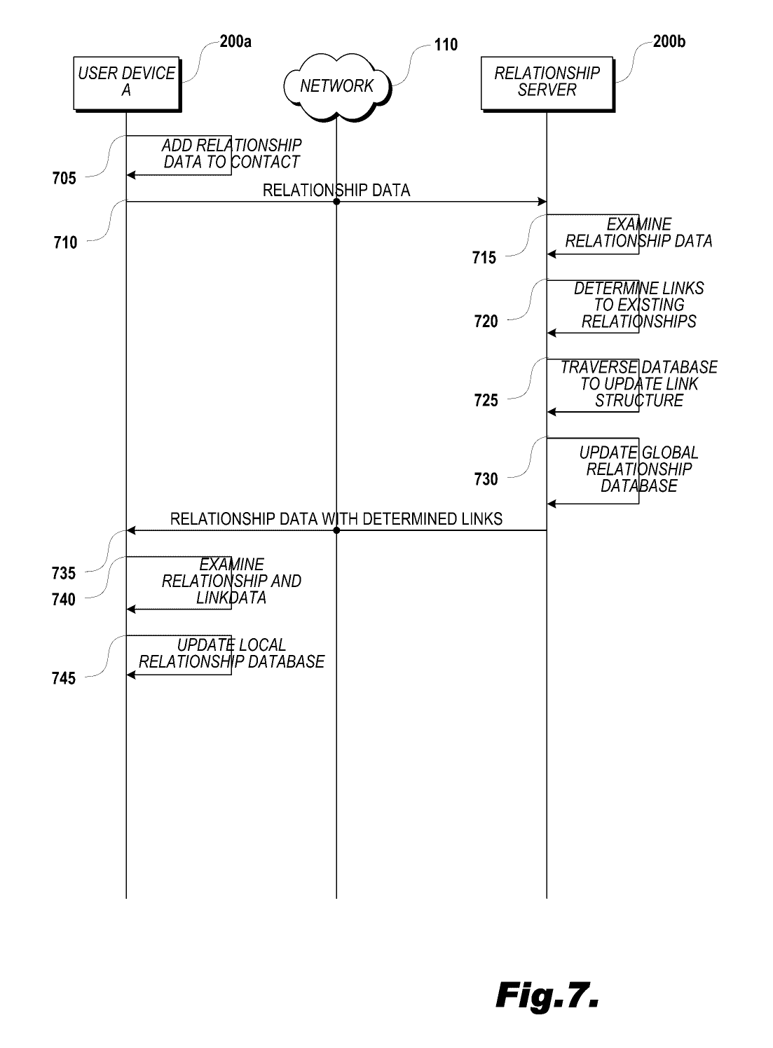

Not all relationship definitions occur in peer-to-peer environments. In some exemplary embodiments, a relationship server 300 may be used to consolidate global relationship information and to analyze relationships between users to determine links. Accordingly, FIG. 7 illustrates an exemplary relationship definition transaction between a first user device 200A and the relationship server 300. In FIG. 7, relationship data is added 705 to a contact at a first user device 200A. The relationship data is sent 710 from first user device 200A to a relationship server 300 via a network 110. The relationship server examines 715, the relationship data and determines any links to existing relationships known to the relationship server (e.g. relationships in a global relationship database 360). The relationship server traverses 725 its database to update the linking that any added relationship data may have caused in the database. The global relationship database is next updated 730 at the relationship server 300. The relationship server 300 may return 735 relationship data with any determined links to update the first user device 200A via the network 110. At first user device 200A, the relationship data is examined 740 along with the link data and the local relationship database (e.g. relationship database 260) is updated 745 with the relationship data and the determined links.

In some embodiments, another device, such as administration device 120, may also be used to manage a global relationship database 360 at the relationship server 300.

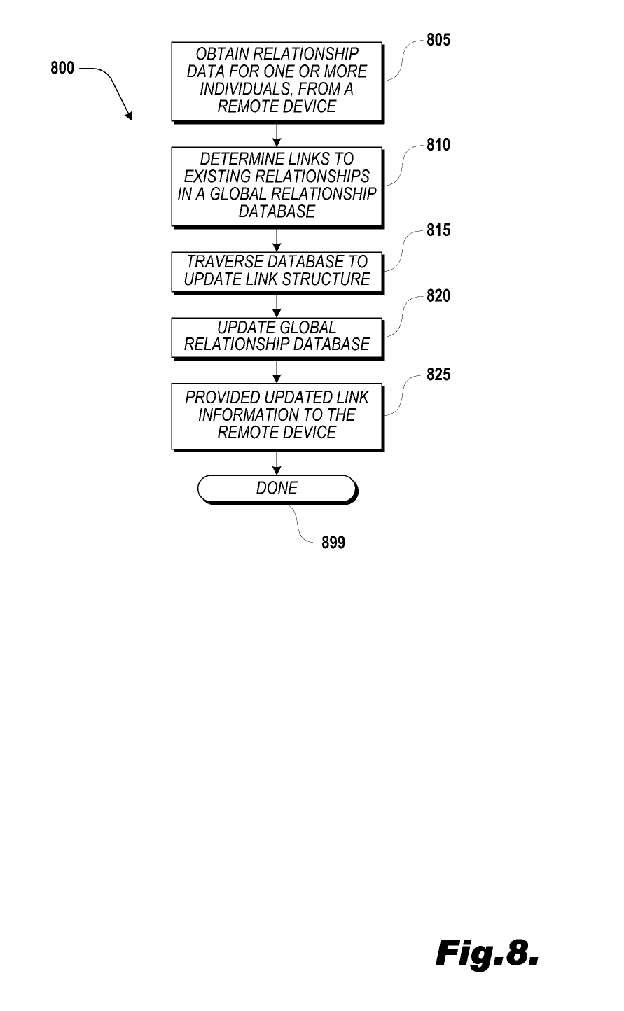

Similar to the operations of the relationship server in FIG. 7, FIG. 8 illustrates a simplified diagram of a relationship and link processing routine for a relationship server 300. Relationship and link processing routine 800 begins at block 805 where relationship data is obtained for one or more individuals from a remote device. Next, in block 810, links to existing relationships in a global relationship database (e.g., global relationship database 360) are determined for the relationship data. In block 815, the global relationship database is traversed to update its link structure and in block 815. Next, in block 820, the global relationship database is updated with the updated link structure. In block 825, the updated link information with corresponding relationship data is provided to the remote device where the relationship was obtained (e.g. a user device 200). Relationship and link processing routine 800 ends at block 899.

In some embodiments, the linking between contacts may be inferred from existing relationships. For example, in a rule-based relationship system where relationships may have associated and reciprocal rules, new relationships may be inferred from existing relationships that have associated rules. Using an analogy of family relationships, if Alice is Bob's brother, and Craig is Bob's son, it can be inferred by that Alice is Craig's Aunt (and Craig is Alice's nephew). An exemplary definition of family relationships using an extensible markup language is shown below:

<?xml version=“1.0” encoding=“utf-8” ?>
− <Family xmlns=“http://www.inkaar.com/Relations”
xmlns:xsi=“http://www.w3.org/2001/XMLSchema-instance”
xsi:schemaLocation=“http://www.inkaar.com/Relations relationtypes.xsd”
Name=“Family” Id=“AAD81FB7-3703-4D6D-AAE0-2EBC018BCBEA”>
<Description />
− <AllPrivacyControls>
− <Access>
<Type>Public</Type>
</Access>
</AllPrivacyControls>
− <Sibling TypeId=“0f583616-24ef-45a2-882b-ca923ce17804”>
<Description />
− <AllInverseRelations>
<Relation>Sibling</Relation>
<Relation>Brother</Relation>
<Relation>Sister</Relation>
</AllInverseRelations>
− <AllDefinitionPatterns>
<DefinitionPattern>/Parent/Child</DefinitionPattern>
</AllDefinitionPatterns>
</Sibling>
− <Parent TypeId=“4e67c62f-605e-421b-87da-141f82ca8884”>
<Description />
− <AllInverseRelations>
<Relation>Child</Relation>
<Relation>Son</Relation>
<Relation>Daughter</Relation>
</AllInverseRelations>
</Parent>
− <Child TypeId=“34a15566-f7db-49c2-acb6-73beebe2e68e”>
<Description />
− <AllInverseRelations>
<Relation>Parent</Relation>
<Relation>Father</Relation>
<Relation>Mother</Relation>
</AllInverseRelations>
</Child>
− <Friend TypeId=“6cd843ae-a8e0-4c7e-ac6b-12b5fef67596”>
<Description />
− <AllInverseRelations>
<Relation>Friend</Relation>
</AllInverseRelations>
− <AllDefinitionPatterns>
<DefinitionPattern>/Friend[@DegreeOfSeparation=
(0..N)]</DefinitionPattern>
</AllDefinitionPatterns>
</Friend>
− <Brother TypeId=“3d398dcc-2638-4c4c-8aea-a8d75aea7703”>
<Description />
− <AllInverseRelations>
<Relation>Brother</Relation>
<Relation>Sister</Relation>
<Relation>Sibling</Relation>
</AllInverseRelations>
− <AllDefinitionPatterns>
<DefinitionPattern>Sibling[@Gender=‘Male’]</DefinitionPattern>
</AllDefinitionPatterns>
</Brother>
− <Sister TypeId=“2d8a1624-d795-4e83-aa64-6f6946bfbb52”>
<Description />
− <AllInverseRelations>
<Relation>Brother</Relation>
<Relation>Sister</Relation>
<Relation>Sibling</Relation>
</AllInverseRelations>
− <AllDefinitionPatterns>
<DefinitionPattern>Sibling[@Gender=‘Female’]</DefinitionPattern>
</AllDefinitionPatterns>
</Sister>
− <Uncle TypeId=“83088c81-36c6-4459-8352-3a622aa5dcf4”>
<Description />
− <AllInverseRelations>
<Relation>Niece</Relation>
<Relation>Nephew</Relation>
</AllInverseRelations>
− <AllDefinitionPatterns>
<DefinitionPattern>/Parent/Brother</DefinitionPattern>
<DefinitionPattern>/Parent/BrotherInLaw</DefinitionPattern>
</AllDefinitionPatterns>
</Uncle>
− <Niece TypeId=“d5551d09-f754-42dd-8e81-1869632fe7e3”>
<Description />
− <AllInverseRelations>
<Relation>Uncle</Relation>
<Relation>Aunt</Relation>
</AllInverseRelations>
− <AllDefinitionPatterns>
<DefinitionPattern>Sibling/Daughter</DefinitionPattern>
<DefinitionPattern>BrotherInLaw/Daughter</DefinitionPattern>
<DefinitionPattern>SisterInLaw/Daughter</DefinitionPattern>
</AllDefinitionPatterns>
</Niece>
− <Nephew TypeId=“5fe38317-3001-4eee-a89e-ca6beadec23e”>
<Description />
− <AllInverseRelations>
<Relation>Uncle</Relation>
<Relation>Aunt</Relation>
</AllInverseRelations>
− <AllDefinitionPatterns>
<DefinitionPattern>Sibling/Son</DefinitionPattern>
<DefinitionPattern>BrotherInLaw/son</DefinitionPattern>
<DefinitionPattern>SisterInLaw/Son</DefinitionPattern>
</AllDefinitionPatterns>
</Nephew>
− <Aunt TypeId=“e2b0403d-c7b8-49c0-a7b0-95d214229877”>
<Description />
− <AllInverseRelations>
<Relation>Niece</Relation>
<Relation>Nephew</Relation>
</AllInverseRelations>
− <AllDefinitionPatterns>
<DefinitionPattern>/Parent/Sister</DefinitionPattern>
<DefinitionPattern>/Parent/SisterInLaw</DefinitionPattern>
</AllDefinitionPatterns>
</Aunt>
− <Father TypeId=“30f71f47-ffba-4f66-9d2a-9fc19fb3803e”>
<Description />
− <AllInverseRelations>
<Relation>Son</Relation>
<Relation>Daughter</Relation>
<Relation>Child</Relation>
</AllInverseRelations>
− <AllDefinitionPatterns>
<DefinitionPattern>Parent[@Gender=‘Male’]</DefinitionPattern>
</AllDefinitionPatterns>
</Father>
− <Mother TypeId=“ab6ddbad-9dba-4e53-89c3-371adb48c89e”>
<Description />
− <AllInverseRelations>
<Relation>Son</Relation>
<Relation>Daughter</Relation>
<Relation>Child</Relation>
</AllInverseRelations>
− <AllDefinitionPatterns>
<DefinitionPattern>Parent[@Gender=‘Female’]</DefinitionPattern>
</AllDefinitionPatterns>
</Mother>
− <Son TypeId=“d9583ed0-5697-4a65-ab5c-b5061d4c45c6”>
<Description />
− <AllInverseRelations>
<Relation>Father</Relation>
<Relation>Mother</Relation>
<Relation>Parent</Relation>
</AllInverseRelations>
− <AllDefinitionPatterns>
<DefinitionPattern>Child[@Gender=‘Male’]</DefinitionPattern>
<DefinitionPattern>Spouse+/Son</DefinitionPattern>
<DefinitionPattern>Wife/Son</DefinitionPattern>
<DefinitionPattern>Husband/Son</DefinitionPattern>
<DefinitionPattern>Son/Brother+</DefinitionPattern>
</AllDefinitionPatterns>
</Son>
− <Daughter TypeId=“823e75fa-0617-4ff7-b955-0d1a8baba760”>
<Description />
− <AllInverseRelations>
<Relation>Father</Relation>
<Relation>Mother</Relation>
<Relation>Parent</Relation>
</AllInverseRelations>
− <AllDefinitionPatterns>
<DefinitionPattern>Child[@Gender=‘Female’]</DefinitionPattern>
<DefinitionPattern>Spouse/Daughter</DefinitionPattern>
<DefinitionPattern>Wife/Daughter</DefinitionPattern>
<DefinitionPattern>Husband/Daughter</DefinitionPattern>
</AllDefinitionPatterns>
</Daughter>
− <Cousin TypeId=“822dce51-9a07-4f83-9008-bfe2c7082005”>
<Description />
− <AllInverseRelations>
<Relation>Cousin</Relation>
</AllInverseRelations>
− <AllDefinitionPatterns>
<DefinitionPattern>Uncle/Child</DefinitionPattern>
<DefinitionPattern>Aunt/Child</DefinitionPattern>
</AllDefinitionPatterns>
</Cousin>
− <Wife TypeId=“96ceb0c6-b7fb-4e1a-bb05-fa18640bc02b”>
<Description />
− <AllInverseRelations>
<Relation>Spouse</Relation>
<Relation>Husband</Relation>
</AllInverseRelations>
− <AllDefinitionPatterns>
<DefinitionPattern>Spouse[@Gender=‘Female’]</DefinitionPattern>
</AllDefinitionPatterns>
</Wife>
− <Spouse TypeId=“142350a4-98cc-4d22-9d17-606a41048eec”>
<Description />
− <AllInverseRelations>
<Relation>Spouse</Relation>
</AllInverseRelations>
</Spouse>
− <Husband TypeId=“46314de8-43b2-443b-9bd9-4c3880691584”>
<Description />
− <AllInverseRelations>
<Relation>Spouse</Relation>
<Relation>Wife</Relation>
</AllInverseRelations>
− <AllDefinitionPatterns>
<DefinitionPattern>Spouse[@Gender=‘Male’]</DefinitionPattern>
</AllDefinitionPatterns>
</Husband>
− <BrotherInLaw TypeId=“67e1306d-8621-40ff-bdc8-68a0c86e7d0a”>
<Description />
− <AllInverseRelations>
<Relation>BrotherInLaw</Relation>
<Relation>SisterInLaw</Relation>
</AllInverseRelations>
− <AllDefinitionPatterns>
<DefinitionPattern>Wife/Brother</DefinitionPattern>
<DefinitionPattern>Husband/Brother</DefinitionPattern>
<DefinitionPattern>Spouse/Brother</DefinitionPattern>
</AllDefinitionPatterns>
</BrotherInLaw>
− <SisterInLaw TypeId=“6ac1006e-f2e2-4076-91dc-64c72c9b0f6b”>
<Description />
− <AllInverseRelations>
<Relation>BrotherInLaw</Relation>
<Relation>SisterInLaw</Relation>
</AllInverseRelations>
− <AllDefinitionPatterns>
<DefinitionPattern>Wife/Sister</DefinitionPattern>
<DefinitionPattern>Husband/Sister</DefinitionPattern>
<DefinitionPattern>Spouse/Sister</DefinitionPattern>
</AllDefinitionPatterns>
</SisterInLaw>
− <FamilyMember TypeId=“bff93416-5362-415c-ac5c-c72c7a7bab5d”>
<Description />
− <AllInverseRelations>
<Relation>FamilyMember</Relation>
</AllInverseRelations>
</FamilyMember>
</Family>

Of course, other extensible markup schemas may be used to represent other groups of relationships. Different organizations may even form their own types of relationship suited to their organization. By using such rule-based relationships, it possible to gather relationship data from multiple sources and combine relationships (at both the user device 200 and the relationship server 300).

Privacy issues are significant when dealing with personally identifiable information about other people. Accordingly, in various embodiments, networks, groups, users, relation types and contacts can each have privacy settings. In one such embodiment, there are four types of privacy settings: public, private, do-not-forward, and contact-through-me. These generally relate to infinite degrees of sharing, no degrees of sharing, one degree of sharing, and managed sharing, respectively. A public contact's information can be shared and re-shared. A private group cannot be shared and will not be seen by other contacts. A do-not-forward can be shared, but not re-shared with others. While a contact-through-me type would list a contact's name, but would route contact requests to the user who shared the contact.

In still alternate embodiments, additional privacy features may be employed, for example encryption of the local relationship database 260, global relationship database 360 and communications with contacts.

In various embodiments, contacts may be arranged in one or more networks and groups of a user. For example, in one exemplary embodiment every user has at least one network having one group (e.g., my network and my group) that may be public or private depending on the user settings. However, a user may desire to create separate networks and/or separate groups within a network to differentiate the relationships and possibly the privacy settings with various contacts. In one exemplary embodiment, a user may have their “my network” network and have a family group and a “work” group within the network. Those individuals invited into the family group would have familial relations with the user and those invited into the “work” group would have work related relations with the user. In further embodiments, still other types of networks having even further groups may be employed. As the types of groups and relations are extensible in various embodiments, the types of relations that may be included and described are limited only to a user's imagination.

The relationship system 100 presents a mechanism to define one or more relations networks by establishing the common network definitions as described above. An entity using relations client application (e.g., that implements routines 500 and 600) either as a standalone or web-based application, may set one or more relations from a group of relation types to target contacts, thereby creating local relations network. In an illustrative instance of relation creation, the user checks for existing known and inferred relations for any existing relation. The user may set a relation to a target contact, specifying the relation type from one of the group of relation types. The relation system 100 establishes a unique identifiable link locally (e.g., in local relationship database 260). The user may then send the relation information to target contact in an e-mail or through some other method.

In addition to sending communications with relationship information, it may be possible to import, export, and integrate relationship information. Some types of relationships are readily susceptible to modeling. For example, family relationships may be modeled using the GEDCOM genealogical modeling language (GEDCOM is an acronym for GEnealogical Data COMmunication and was developed by The Church of Jesus Christ of Latter-day Saints). Accordingly, it may be beneficial to be able to export specified relationships into a GEDCOM format. Likewise, given a list of contacts and a GEDCOM file, it may be possible to import the list of contacts and GEDCOM file to create a set of contacts that have relationships specified from the GEDCOM file (e.g., through name/age/gender matching and possible user queries for ambiguous matches).

In some embodiments, it may be desirable to create fictional networks and/or groups. Fictional networks and groups are at least partially composed of entities (contacts) that are fictional and accordingly would not participate in the operation of the network and/or group. Such fictional networks may be suited for modeling and/or illustrating relationships between and amongst fictional and/or historical characters. For example, a genealogy that included individuals that were no longer living might be one form of fictional group. Likewise, a group that included fictional characters from a story would be another form of fictional group. Given the complexity of many written works of fiction, it may be desirable to use fictional networks and groups to illustrate the relationships between characters for a user.

Of course importing and exporting of relations may also be governed by privacy settings. Accordingly, if a user, group, type, or contact specifies a “private” setting, they may by default not be exported. However, as the user may have set those privacy settings in the first place, they may also be overridden.

In various embodiments, relationships may be defined synchronously and asynchronously. A relationship is a parseable relation that has a schema associated with it. The parseable relation helps in organizing contacts into logical groups, and searching relations based on conditions in the relation definitions. The relation definitions enable inferring unknown relations from known relations.

Inferring relations may happen periodically in relationship databases or in real-time when a user queries for contact(s) based on a relationship type. For example, even if a user specified that Alice is Bob's sister, and that Bob is Craig's father, it can be inferred that Alice is Craig's Aunt. Looking at the exemplary family relationship schema listed above, a relationship path from Craig to Alice would look like: “relationship: parent (father)+relationship: sister=relationship: aunt.” By using predefined relationships that have forward and inverse relationship rules, it is possible to combine relationships into paths to infer relations between contacts that do not have specified relationships.

Since the predetermined relation types (as listed in schemas) are bounded, the growth in number of entities would not cause a relation network to be reorganized. This type of network may be useful in defining family networks, work place networks, computer networks, and other types of custom networks.

In some embodiments, a contact may have one or more aliases. Aliases may be used to group various contact addresses (e-mail, chat, phone, and the like) which belong to the same contact. Relations are generally set between two contacts. Having aliases eliminates setting relations repeatedly when you already have a relation with the same person (but different address). Aliases provide flexibility and simplicity to update and view relations independent of which address has been used to set the relation. Setting an alias would also automatically synchronize the messages and relation history for all of the sender's communications (e-mail, chat logs, voicemail, etc.) if there is a relation set with at least one of the aliases of that contact.

In various embodiments, it is possible to search networks and/or groups to find entities. Searching may be accomplished by conventional searching mechanisms, such as keyword searchers. However, in additional embodiments, it may be desirable to search for entities based on their relations to other entities. A relation search would be accomplished by searching for entities linked with a specific relationship type and identifying relationships corresponding to the relationship type to locate any matching or entities. Accordingly, a relationship search may start from a known entity and evaluate possible relations and combinations of relations to locate a desired entity or entities. For example, searching for “Bill's Friend in Redmond” would start with the known entity Bill and look for other entities that have a “friend relationship” with Bill and who are located in the town of Redmond.

Likewise, it may be possible to search for relation groups according to similar criteria such as described above with regards to Ad Hoc Groups.

Additionally, once a specific entity have been located, it may then be possible to determine the relations that lead to that entity (either from the user or to any other entity that has a chain of relations to the other entity).

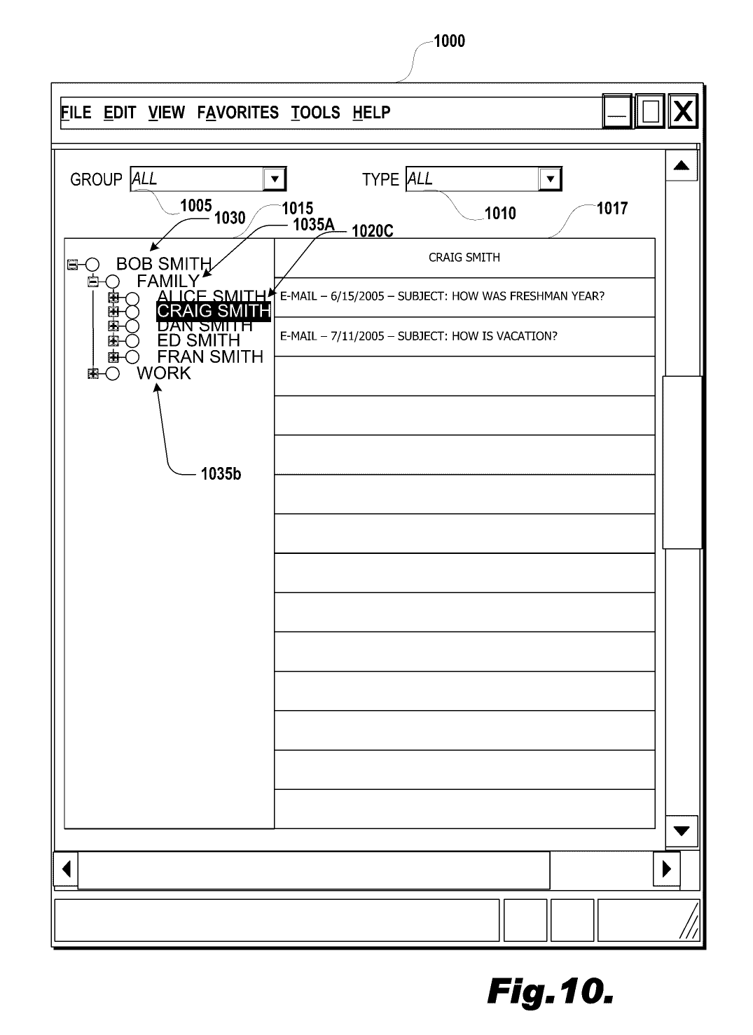

As noted above, communications may be synchronized to capture relation history. Synchronization captures communications with a defined relation (see, for example, FIG. 10). Synchronization, in other words, captures the message history and relation history with a contact. This information may also be used to assist in determining the characteristics of a relationship (e.g., strength, happiness, etc.). Synchronizing of messages may be done periodically or as prompted by a user. Likewise, all communications may be synchronized, or only a selected subset of communications may be synchronized. Organizing communication histories as relation histories enables users to group information based on predetermined relations, groups, or ad hoc groups resulting from search and inference.

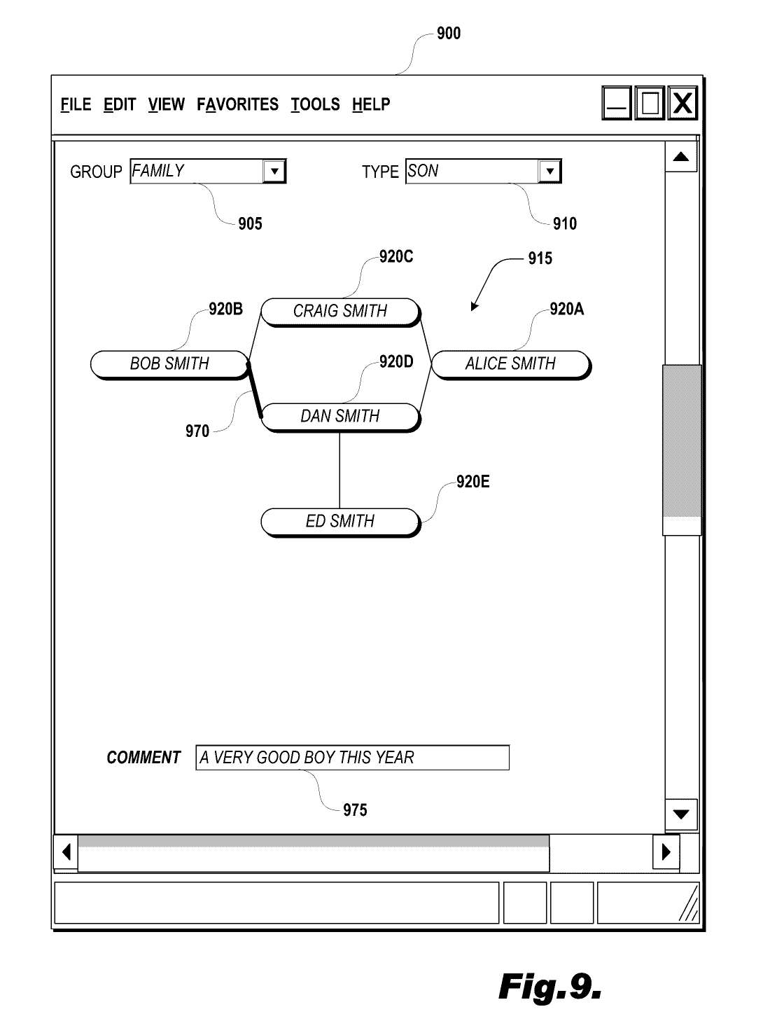

To better illustrate the operations of the transaction and routines described above, FIGS. 9-11 illustrate exemplary user interfaces (“Uls”) suitable for various embodiments.

The relationships indicated in a global relationship database form a “network” of connections that have their own structure. Accordingly, FIG. 9 is a screen shot of an exemplary UI 900 for graphically illustrating the network of relationships between contacts. In UI 900, there are two selection boxes, 905 and 910. Group selection box 905 is used to select the relation group of interest and relationship block 910 selects the type of relationship of interest. While these selections are shown as drop-down selection boxes, in other user interfaces they may be show in other forms (e.g., list boxes, text boxes and the like).

In the screenshot illustrated in FIG. 9, the selected relation group is “FAMILY” and the type of relation is “SON”. Accordingly, the illustrated contacts 920A-E all have a “SON” type relationship with the contact to which they are connected. For example, “Dan Smith” 920D is the “SON” of “Alice Smith” 920A. Likewise, “Ed Smith” 920E is the “SON” of “Dan Smith” 920D. Using such a UI, it would then be possible to search for contacts based on their relationships to other contacts.

Also shown in FIG. 9 is a link 970 between the contacts 920B and 920D. The link 970 may include additional information about the link itself as can be seen from the comment 975. In various embodiments, notes and/or other metadata for the link 970 may be public, private, or otherwise directed to a limited number of entities using the system's privacy settings.

In further embodiments, it may be possible to search for contacts using additional criteria. For example, search in group “FAMILY” with a location of “Los Angeles” would return an “ad hoc” group of contacts that meet the criteria of being in the FAMILY group and residing in Los Angeles. Likewise other properties of a contact (e.g., name, profession, gender, age, and the like) could be used to search the contacts in addition to the groups and relations types of the contacts.

In some embodiments, such ad hoc groups could be cached or even saved. However, unlike explicit groups, such groups are based on the qualifying criteria. Accordingly, if a contact moved residence out of Los Angeles, they would no longer be a part of FAMILY in the Los Angeles ad hoc group.

Entities, such as contacts 920A-E, may have notes and/or other metadata (such as age, gender, location, and the like) associated with them to enable these additional search criteria. Furthermore, in some embodiments, a user may arbitrarily tag one or more entities with further metadata to enable grouping and/or searching of the data.

Additionally, some embodiments utilizing relationship-based searches will also provide the relationship path between a user and the searched for contact(s). As there may be multiple paths between the user and the contact(s), some embodiments may search for a relationship path from both the user and the contact; hopefully minimizing the possible permutations that need to be searched to find a path between the two. It is worth noting that a relationship path may include one or more relationships that are inferred from known and/or proposed relationships between contacts.

FIG. 10 is a screen shot of an exemplary UI 1000 for locating associated information to a specified contact. In the illustrated UI 1000, user “Bob Smith” 1030 is listed as having two groups of relations, “FAMILY” 1035A and “WORK” 1035B. The selection boxes 1005, 1010 are both set to include all groups and all types. Contact “Craig Smith” 1020C is highlighted, and in information panel 1017, there is a listing of communications with “Craig Smith” 1020C. The UI is one example of a UI that may be used with an exemplary relationship system to search for information based on relationships. The UI 1000 is suitable for locating information specific to a particular contact, and categorized by their relationship to the user.

While a variety of methods may be used to assign relationships to a contact, including, but not limited to, accepting a proposed relationship, manually configuring relationship data, receiving linked relationship data and the like. FIG. 11 illustrated an exemplary UI 1100 for assigning relationships to contacts. In the exemplary UI 1100, a user is selected in the user selection box 1105. Next, the user's relations with listed contacts are selected based on relationship groups and types in the relationship selection area 1110. The user may then save the relationship(s) (as proposed relationships) by selecting a save button 1115, or may cancel the relationship setting via a cancel button 1120.

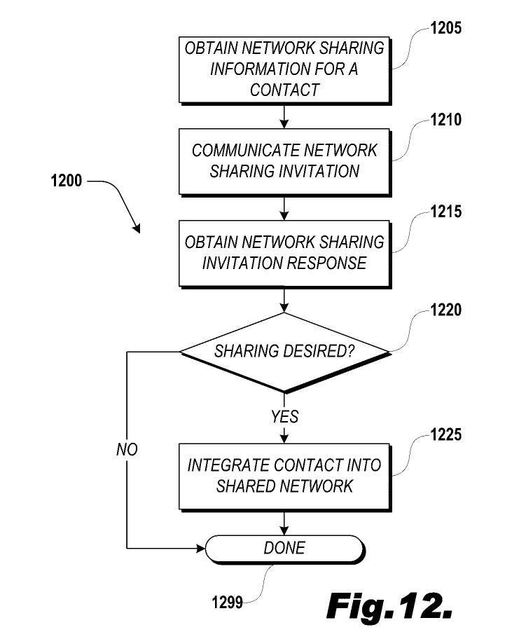

In some embodiments, users may wish to share their networks with other users. Accordingly, FIG. 12 shows an exemplary network sharing routine 1200. Network sharing routine 1200 begins at block 1205 where network-sharing information is obtained for a contact. The network sharing information is communicated in block 1210 to the desired contact that the user wishes to share their network with. In block 1215, a network sharing invitation response is obtained. After which, in decision block 1220, a determination is made whether the invited contact wishes to share the user's network. If so, processing proceeds to block 1225 where the contact is integrated into the sharing network. Processing then proceeds to block 1299 where network sharing routine 1200 ends. If in decision block 1220 it was determined that the invited contact does not wish to share the network, processing likewise will proceed to block 1299 where network sharing routine 1200 ends.

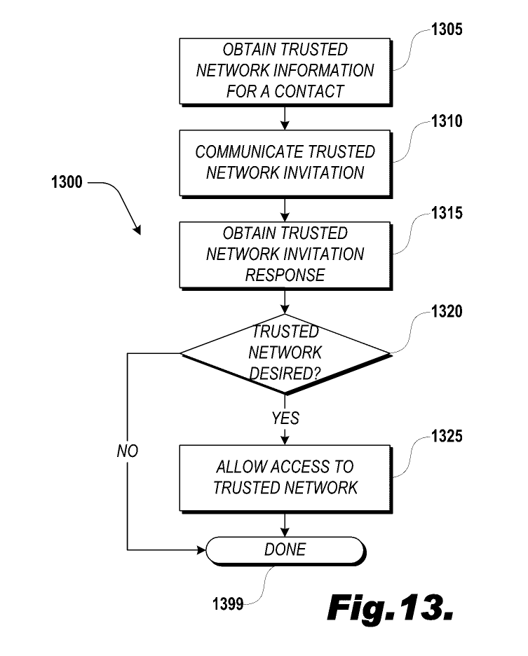

In some embodiments, users may wish to trust their networks with other users. Accordingly, FIG. 13 shows an exemplary network trust routine 1300. Network trust routine 1300 begins at block 1305 where trusted network information is obtained for a contact. The trusted network information is communicated in block 1310 to the desired contact that the user wishes to trust their network with. In block 1315, a trusted network invitation response is obtained. After which, in decision block 1320, a determination is made whether the invited contact wishes to trust the user's network. If so, processing proceeds to block 1325 where the contact is allowed access to the trusted network. Processing proceeds to block 1399 where trusted network routine 1300 ends. If in decision block 1320 it was determined that the invited contact does not wish to trust the network, processing likewise will proceed to block 1399 where trusted network routine 1300 ends.

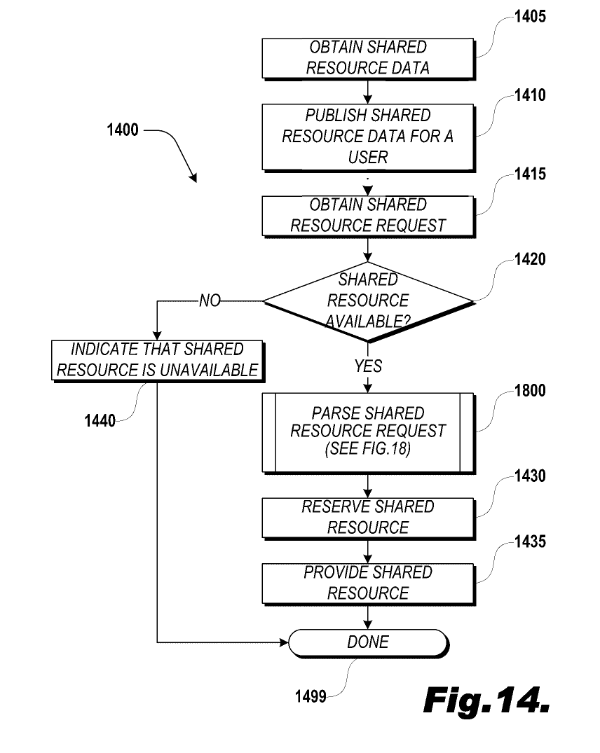

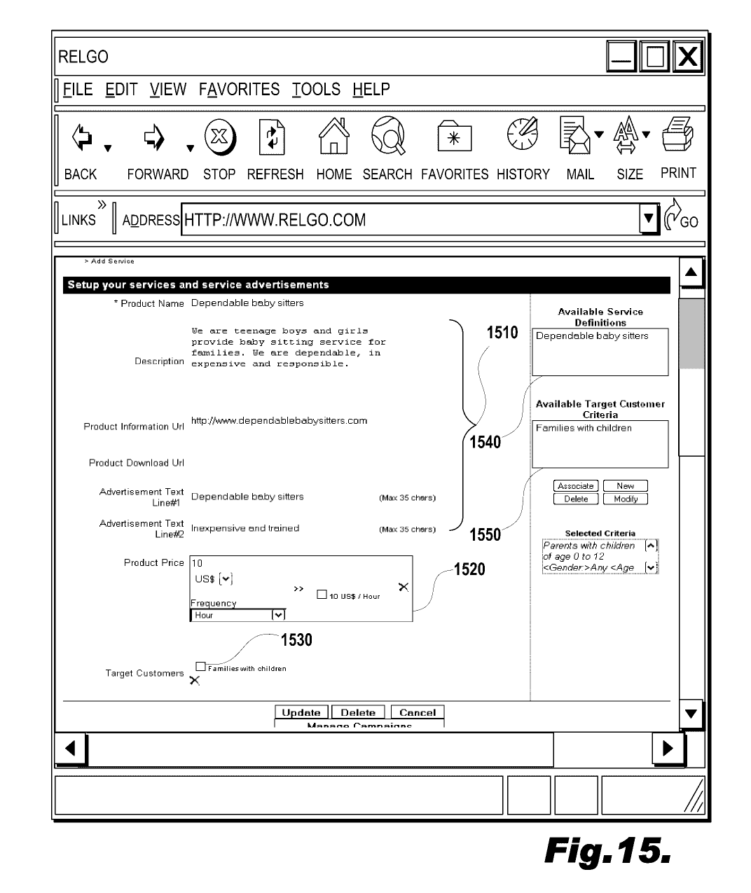

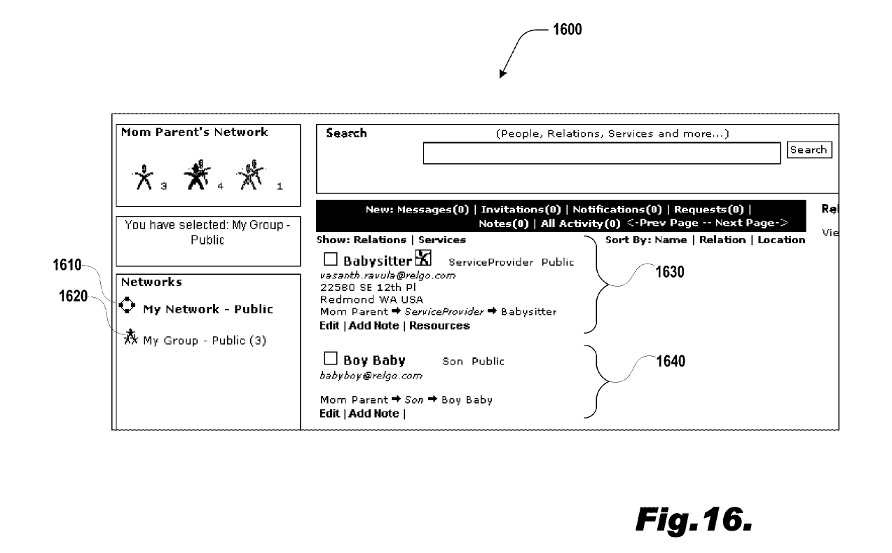

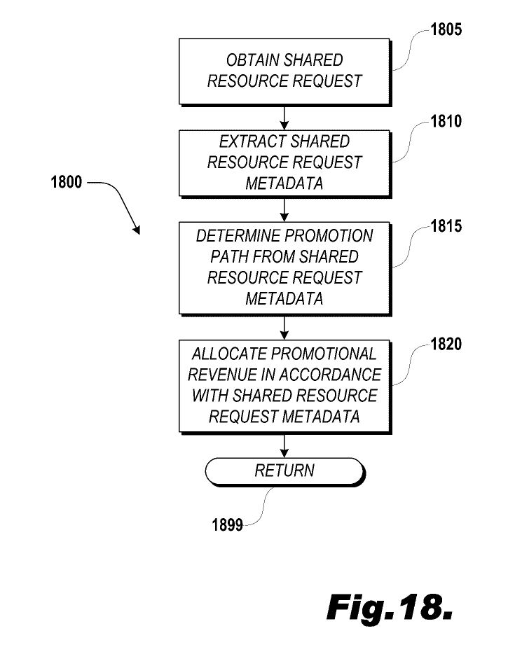

In addition to simply modeling and communicating information between related users, various embodiments may allow further interactions between contacts. For example, in some embodiments it may be desirable for a user to share their resources (either physical resources services or other resources) with their contacts. FIG. 14 illustrates an exemplary resource sharing routine 1400. Resource sharing routine 1400 begins at block 1405 where shared resource data is obtained. One example of obtaining shared resource data is shown in the exemplary user interface 1500 illustrated in FIG. 15 and described below. In block 1410, the shared resource data is published for a user. Eventually, in block 1415, a shared resource request is obtained. In decision block 1420, a determination is made whether the shared resource is available in accordance with the shared resource request (e.g. is the number of resources available at the time requested in the shared resource request). If so, processing proceeds to subroutine block 1800 where the shared resource request is parse. A shared resource request passing subroutine 1800 is illustrated in FIG. 18 and described below. Once the shared resource request has been passed, processing proceeds to block 1430, where the shared resource is reserved. And in block 1435 the shared resource is provided (or may simply be marked as having been provided if the resource is not a virtual resource that could be provided by a routine). Processing proceeds to block 1499 where shared resource routine 1400 ends. If, in decision block 1420, it was determined that the shared resource was unavailable, processing proceeds or would proceed to block 1440 where an indication that the shared resource is unavailable is provided to the shared resource requester. Next, processing proceeds to block 1499.

FIG. 15 illustrates an exemplary user interface 1500 for entering information about a shared resource. The illustrated user interface 1500 shows a service resource of babysitting that includes information about the “product” 1510 and the product price 1520 also included are target customers 1530 and available service definitions 1540. Along with available target customer criteria 1550, by providing product information 1510 price information 1520 and the other descriptive and targeting information 1530, 1540 and 1550, a user is able to describe a shared resource in enough detail for other contacts within their networks to determine if the resource would be beneficial.

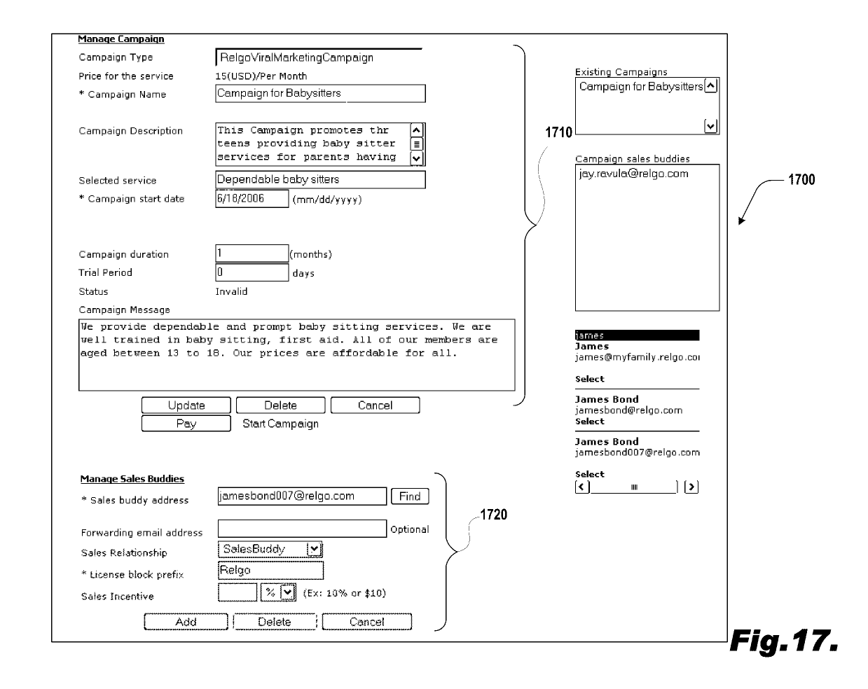

In still further embodiments, it may be desirable to promote shared resources within a network, such that there is an incentive for contacts within a network to promote the resources provided by other contacts within the networks. FIG. 17 illustrates an exemplary promotion campaign user interface 1700 that includes promotion information 1710 and promoter information 1720. Such promotion campaigns may provide some form of incentive (e.g. monetary or other incentive) to contacts within a network that promote another contact's shared resource. For example, if user A is a babysitter and they want to use other people to promote their services, they may say that anyone who connects them with a babysitting engagement may receive a designated monitory amount or a percentage of the money that user will receive. Accordingly, in one specific example, if user A is a babysitter who asks contact B to promote their services in exchange for 10% of the money that user A will receive for a designated babysitting engagement provided by contact B, and contact B promotes user A to user C who then engages user A's babysitting services for $10.00 an hour for 5 hours, then contact B would have earned a $5.00 promotion percentage from user A. In other embodiments, a user may designate a specific promotion campaign amount they are willing to dedicate towards promotions, and other users within the network would receive either $6.00 or percentages out of that promotional campaign amount. For example, a user may say “I am willing to spend $40.00 for promoting my babysitting services, and for each of the next 10 engagements I get, I will pay a $4.00 referral fee.” In such a scenario, the first ten referrals would get a $4.00 referral fee, after which the promotion campaign would end.

In order for the promotion campaigns to operate efficiently, in some embodiments it may be desirable to determine the path from which a shared resource request originates. FIG. 18 illustrates the exemplary shared resource request passing subroutine 1800. Shared resource request passing subroutine 1800 begins at block 1805 where a shared resource request is obtained. In block 1810 the shared resource request metadata is extracted. One example of such metadata might include promotion metadata that would have been included in a shared resource request that went through a promotional campaign. Below is an example metadata used in one specific implementation of promotion tracking:

<multilevelincentivepath>
<serviceid>5c24d988-c0da-4a61-b236-a37e259925b6</serviceid>
<campaigned>4ca39e47-afde-4d6f-9241-aa759072b529</campaignid>
<>
<relationid>ab2719bb-eea2-486a-b145-6fccbc465dc5</relationid>
<expiration>7/18/2006</expiration>
<incentive>100%</incentive>
</relation>
<relationid>cb2719bb-eea2-486a-b145-6fccbc465dc5</relationid>
<expiration>7/18/2006</expiration>
<incentive>50%</incentive>
</multilevelincentivepath>

Next, in block 1815, the promotion half (if any) is determined from the shared resource request metadata. In block 1820 any promotional revenue is allocated in accordance with the determined promotion task described in the shared resource metadata. In block 1899 shared resource request-passing subroutine 1800 returns to its calling routine.

Although specific embodiments have been illustrated and described herein, it will be appreciated by those of ordinary skill in the art that a wide variety of alternate and/or equivalent implementations may be substituted for the specific embodiments shown and described without departing from the scope of the present invention. This application is intended to cover any adaptations or variations of the embodiments discussed herein. Therefore, it is manifestly intended that this invention be limited only by the claims and the equivalents thereof.

What is claimed is:

1. A computer-implemented method of sharing a network of defined relationships, the method comprising:
specifying a predefined relationship with a contact;
including said predefined relationship and said contact in the network;
communicating network sharing data to said contact via a remote device;
obtaining a response via said remote device to said network sharing data;
if said response indicates a shared network, updating a database to indicate that the network is shared with said contact; and
granting shared network privileges to said contact.

2. The method of claim 1, further comprising modifying the network in response to a modification request from said contact.

3. The method of claim 1, further comprising accessing the network in response to an access request from said contact.

4. A computer-readable medium comprising computer-executable instructions for performing the method of claim 1.

5. A computing apparatus comprising a processor and a memory having computer-executable instructions for performing the method of claim 1 when executed by said processor.

6. A computer-implemented method of trusted access to a network of defined relationships, the method comprising:
specifying a predefined relationship with a contact;
including said predefined relationship and said contact in the network;
communicating trusted network data to said contact via a remote device;
obtaining a response via said remote device to said trusted network data;
if said response indicates a trusted network, updating a database to indicate that the network is trusted with said contact; and
granting trusted network privileges to said contact.

7. The method of claim 6, further comprising accessing the network in response to an access request from said contact.

8. A computer-readable medium comprising computer-executable instructions for performing the method of claim 6.

9. A computing apparatus comprising a processor and a memory having computer-executable instructions for performing the method of claim 6 when executed by said processor.

10. A computer-implemented method of sharing a resource with a network of defined relationships, the method comprising:
obtaining shared resource data;
publishing a representation of said shared resource data;
obtaining a request to share said shared resource from a contact with access to said published representation of said shared resource data;
determining that said shared resource is available for sharing; and
allowing sharing of said shared resource.

11. The method of claim 10, further comprising tracing at least relation to said contact.

12. The method of claim 10, further comprising determining a referral origin of said request.

13. The method of claim 10, further comprising allocating a referral fee for said shared resource.

14. The method of claim 13, further comprising paying at least a portion of said referral fee to a determined origin of said request.

15. A computer-readable medium comprising computer-executable instructions for performing the method of claim 10.

16. A computing apparatus comprising a processor and a memory having computer-executable instructions for performing the method of claim 10 when executed by said processor.

17. A computer-implemented method of creating a network of defined fictional relationships, the method comprising:
identifying a first fictional entity;
specifying a predefined relationship for a second fictional entity from said first fictional entity in a network; and
updating a database with said predefined relationship between said first and second fictional entities.

18. The method of claim 17, further comprising including a non-fictional entity in said network.

19. A computer-readable medium comprising computer-executable instructions for performing the method of claim 17.

20. A computing apparatus comprising a processor and a memory having computer-executable instructions for performing the method of claim 17 when executed by said processor.

21. A computer-implemented method of defining a relationship, the method comprising:
identifying a predefined relationship for a contact from a user;
communicating a message to said contact via a remote device, wherein said message comprises an indication of said relationship;
obtaining a response to said message via said remote device, wherein said response comprises a representation of additional information about said relationship;
adding supplemental information about said relationship as metadata; and
updating a database with said additional information for said relationship.

22. The method of claim 21, wherein said supplemental information describes said relationship.

23. The method of claim 21, wherein said supplemental information describes said contact.

24. A computer-readable medium comprising computer-executable instructions for performing the method of claim 21.

25. A computing apparatus comprising a processor and a memory having computer-executable instructions for performing the method of claim 21 when executed by said processor.
